(19) United States
(12) Patent Application Publication
(10) Pub. No.: US 2012/0121099 A1
(43) Pub. Date: May 17, 2012

(54) AID TEST SYSTEM

(75) Inventor: William S. Woods, Berkeley, CA (US)

(73) Assignee: Starkey Laboratories, Inc., Eden Prairie, MN (US)

(21) Appl. No.: 12/944,531

(22) Filed: Nov. 11, 2010

(51) Int. Cl. H04R 29/00

(52) U.S. Cl. 381/60

(57) ABSTRACT

This disclosure relates to a method and apparatus for diagnosing operation errors in hearing assistance devices, including but not limited to hearing aids. The hearing assistance device includes a microphone and a receiver. In various approaches, a housing is configured to hold the hearing assistance device and to provide a controlled acoustic environment between the microphone and receiver. A lid is configured to cover an opening in the housing to seal the housing from external sounds, in various approaches. In some examples, the hearing assistance device is configured to detect placement of the lid on the housing from within the housing and, once placement is detected, output acoustic signals through the receiver and compare resulting microphone input to baseline parameters to diagnose calibration errors.

### TECHNICAL FIELD

This disclosure relates to hearing assistance devices and more particularly to testing hearing assistance devices, such as hearing aids.

### BACKGROUND

Hearing assistance devices, such as hearing aids, process sound played for a user of the device. The calibration of hearing aid transducers (i.e., microphones and receivers) is essential to appropriate functioning of the aid, but calibration may change over time due to transducer aging or failure and/or foreign material accumulation. While users are typically shown how to remove foreign material, this is often not done or not done correctly and the resulting poor calibration results in extra effort on the dispenser's part in diagnosing and fixing the calibration problem. In addition, users typically cannot tell the difference between poor calibration due to transducer problems or foreign material problems, which also results in extra effort on the dispenser's part since the user will bring the aid to the dispenser when they could fix the problem on their own. Also, mis-calibration of dual-microphone systems may not be detected at all by a user or a dispenser, but may lead to worsening performance of a directional array system.

US 2008/0253579 A1 teaches addressing the calibration issue using a housing that contains extensive hardware, such as a microphone and a controller and communications interface. This could greatly increase the expense of the system, however.

Thus, it is desirable to have an inexpensive, straightforward, and repeatable system for diagnosing hearing assistance devices. This will reduce the effort expended by the user and dispenser in diagnosing and alleviating problems due to problems with the hearing assistance device or devices.

### SUMMARY

This document provides method and apparatus for diagnosing operation errors in hearing assistance devices, including but not limited to hearing aids. A hearing assistance device typically includes at least one microphone for an acoustic input and a receiver to provide a sound output. In various applications, a housing is configured to hold the hearing assistance device and to provide a controlled acoustic connection between the microphone and receiver. In various examples, a lid is configured to cover an opening in the housing to seal the housing from external sounds. The hearing assistance device is programmed to output acoustic signals through the receiver and receive signals from the receiver with the microphone. In various applications, the hearing assistance device is adapted to perform these steps upon detection that the lid is placed on the housing. In various embodiments, the hearing assistance device is adapted to compare resulting microphone signals to baseline parameters to diagnose calibration errors. In various embodiments, the comparison is done by another processing device, such as a programmer.

This Summary is an overview of some of the teachings of the present application and is not intended to be an exclusive or exhaustive treatment of the present subject matter. Further details about the present subject matter are found in the detailed description and the appended claims. The scope of the present invention is defined by the appended claims and their equivalents.

### BRIEF DESCRIPTION OF DRAWINGS

FIG. 1 is a block diagram of a system for diagnosing operation errors in a single hearing assistance device, according to one embodiment of the present subject matter.

FIG. 2 is a block diagram of a system for diagnosing operation errors in multiple hearing assistance devices, according to one embodiment of the present subject matter.

FIG. 3 is a block diagram of a system for diagnosing operation errors in a single hearing assistance device including an electrical connection to the hearing aid, according to one embodiment of the present subject matter.

FIG. 4 is a block diagram of a system for diagnosing operation errors in a single hearing assistance device including electronics for signaling the hearing aid, according to one embodiment of the present subject matter.

### DETAILED DESCRIPTION

The following detailed description of the present invention refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is, therefore, not to be taken in a limiting sense, and the scope is defined only by the appended claims, along with the full scope of legal equivalents to which such claims are entitled.

This present subject matter provides for inexpensive, user-accessible, and repeatable diagnosis of hearing assistance device operation errors and for communicating the source of the errors to the user or dispenser. An embodiment includes a housing for the hearing assistance device (or devices) that allows the microphone and receiver of the device to communicate acoustically in a highly repeatable fashion. The system uses software routines that perform diagnostics when operated inside of the housing. The communication can be performed in a variety of ways, including, but not limited to, using the hearing assistance device, by reading information from the device using fitting or other software, and/or lights or other indicia on the housing or device. In the last example, the housing would include a means for accepting commands or data from the hearing assistance and acting accordingly. By allowing the hearing assistance device (or devices) to conduct the calibration procedures internally, unnecessary hardware in the housing can be avoided and the expense of the system can be reduced.

The present subject matter includes hearing assistance devices, including but not limited to, cochlear implant type hearing devices, hearing aids, such as behind-the-ear (BTE), in-the-ear (ITE), in-the-canal (ITC), or completely-in-the-canal (CIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user. It is understood that other hearing assistance devices not expressly stated herein may fall within the scope of the present subject matter. While the present disclosure refers to hearing aids, it is understood that any of the above-mentioned hearing assistance devices can be used without departing from the scope of the present subject matter.

The disclosed housing holds the hearing assistance device/devices (such as hearing aid/aids) in such a manner as to provide an acoustic connection from the receiver to the microphone. One result is that the parameters of such devices are highly stable with removal and replacement of the devices in the housing. The acoustic connection is repeatable, as any variance in the connection will be manifested substantially as an erroneous variance in measures of the parameters of the transducers.

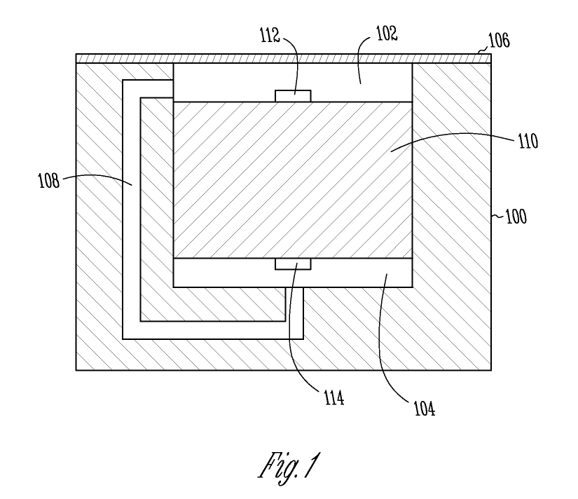

FIG. 1 shows a cross-section of one embodiment of a housing 100 with a single hearing aid 110 inside. The aid 110 is seated with its microphone 112 open to the cavity 102 and its receiver 114 open to the cavity 104. The two cavities 102, 104 are connected acoustically by the tube or channel 108. A lid 106 is configured to cover an opening in the housing 100 to seal the housing from external sounds. Other embodiments have the aid(s) suspended in a single cavity with no tube, thus the sound environment in such designs is repeatable insofar as the aid can be repeatedly suspended in the same orientation within the housing. In various embodiments symmetry is employed to provide a more uniform sound environment and reduce effects of changing alignment of the hearing aid. In such embodiments, the transfer function(s) from receiver to microphone(s) is/are configured to remain constant between removing and replacing the aid(s) in the housing.

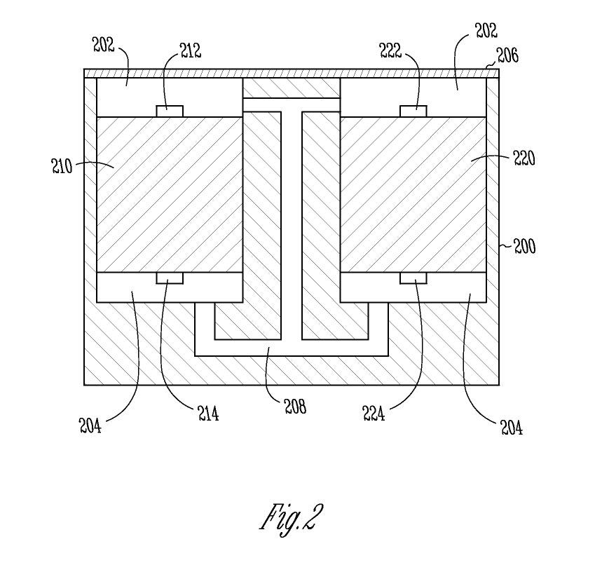

FIG. 2 shows a cross-section of an embodiment of a housing 200 with two hearing aids inside. The first hearing aid 210 is seated with its microphone 212 open to the cavity 202 and its receiver 214 open to the cavity 204. The second hearing aid 220 is seated with its microphone 222 open to the cavity 202 and its receiver 224 open to the cavity 204. The two cavities 202, 204 are connected acoustically by the tube 208. A lid 206 is configured to cover an opening in the housing 200 to seal the housing from external sounds.

The housing 200 and lid 206 greatly reduce extraneous sound energy that could affect diagnostic calibration testing. In addition, because the testing requires output from the aids that might be annoying to listeners nearby, the leakage out of the aid is also controlled by the housing. Other physical parameters of the connection (volume, length, etc.) can be controlled from housing to housing, and the parameters of a given housing are stable over time and usage. Assessment of these parameters and storage of the values in the aid at manufacturing calibrate out any variance.

When placed in the housing with the lid closed, the aid is adapted to detect that it is in the housing. In one embodiment, the lid, when closed, depresses a button on the aid. In various embodiments a means for depressing the button is employed. In one example, an arm is positioned to actuate a switch on the hearing assistance device (hearing aid). In one embodiment, the lid includes a surface adapted to press a button on the hearing assistance device.

In various embodiments, the hearing assistance device results in setting the housing to a testing state when the lid is closed. Other inputs are possible without departing from the scope of the present subject matter.

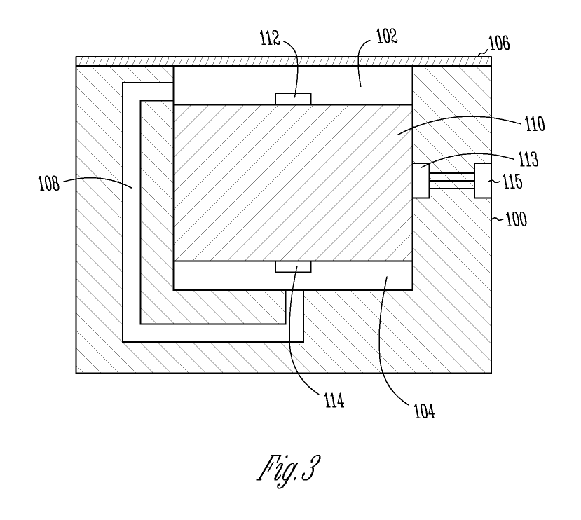

FIG. 3 is a block diagram of a system for diagnosing calibration errors in a single hearing assistance device including an electrical connection to the hearing aid, according to one embodiment of the present subject matter. In various embodiments, the hearing assistance device is electrically connected to a connector 113, which is then in turn connected to another connector 115 via wires. Although three wires are shown for purposes of illustration, other numbers of wires may be used without departing from the scope of the present subject matter. In various embodiments, fewer wires are employed. In various embodiments more wires are employed. In various embodiments, the electrical connection is provided to charge the hearing assistance device. In various embodiments a DAI (direct audio input) connection is used to communicate with the hearing assistance device. In various embodiments, the electrical connection is used to initiate a testing state. Other connections may be performed without requiring an external connector, for example to internal electronics. Variations in connections and positions of connectors are possible without departing from the scope of the present subject matter.

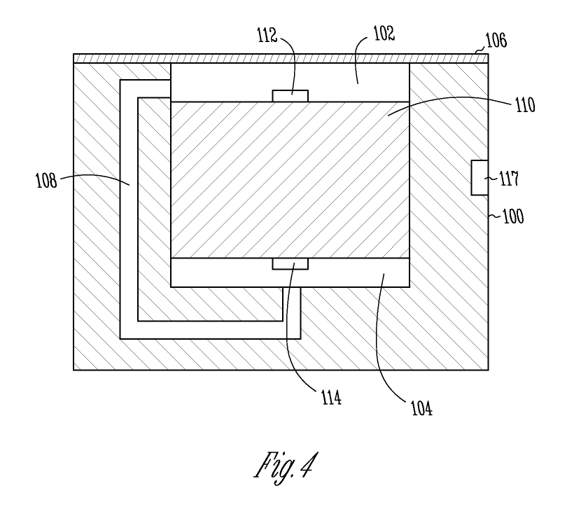

FIG. 4 is a block diagram of a system for diagnosing calibration errors in a single hearing assistance device including electronics for signaling the hearing aid, according to one embodiment of the present subject matter. Electronics 117 can be used to generate signals for communications with the hearing assistance device. Such communications may include initiation or termination of a testing procedure. Such communications may include telemetering data from the hearing assistance device. Electronics 117 may include a pushbutton or other switch or control or sensor. Such button, switch or control or sensor may be used for initiating and/or terminating a test procedure. In various embodiments the housing includes components that produce a magnetic or electromagnetic signal that is sensed by the hearing assistance device(s) (e.g., hearing aid(s)).

While FIGS. 3 and 4 are demonstrated with a single hearing assistance device, it is understood that other numbers of hearing assistance devices may be accommodated in variations of these embodiments. Accordingly, these aspects may be found in variations of the design of FIG. 2, for example. Other variations are possible without departing from the scope of the present subject matter.

In one embodiment, a magnet or magnetic source associated with the placement of the lid is used to trigger a diagnostic mode using the telecoil or other magnetically sensing aspect of the hearing aid(s). In one embodiment, a timer is used that starts when activated by the user. The timer permits a fixed amount of time for the aid(s) to be placed in the housing and securement of the lid. When the timer reaches a predetermined count, the aid(s) can begin the testing procedure. In one embodiment, a magnetic or radio or acoustic signal is used to trigger the testing procedure. Such applications can be performed using a programmer or using a conventional device, such as a DTMF pad, or another conventional device adapted to provide the proper programming signal. Other lid sensing and/or testing procedure activation approaches are possible without departing from the scope of the present subject matter.

In various embodiments, the housing interacts with the aid, for example, the housing also includes a charger for the battery in the aid in an embodiment.

Various embodiments include single- and dual-aid diagnostics. In the single aid case, once detected to be in the housing, the single aid outputs acoustic signals through its receiver and compares statistics of the resulting microphone output or outputs to stored parameters. In some embodiments, the parameters are stored in the aid. In various embodiments, the parameters are stored in a programmer. In various embodiments, the parameters are stored in another device adapted to assist the testing function. In various embodiments, the comparison is done by the hearing assistance device. In various embodiments, the comparison is done by a programmer. In various embodiments, the comparison is done by another device adapted to assist the testing function. The stored parameters are the baseline calibration of the aid/housing combination conducted at some earlier time. In various embodiments, the parameters include parameters stored just after the aid(s) is/are manufactured. Variance from the stored parameters, given the stable acoustics of the aid/housing combination, indicates a change in either the microphone or the receiver or both. According to various embodiments, patterns in the statistics can be used to differentiate between microphone and receiver problems. Various embodiments include a current monitor for differentiation (for instance, if the problem is due to an open circuit with the receiver much less current would be drawn than is usual). Other methods for differentiation can be used (e.g., sending voltage pulses through the microphone and comparing statistics of the output to pre-recorded values). Repetition of stimuli and synchronized averaging of responses are used to overcome noise floor problems, according to various embodiments.

In the dual-aid embodiment, the diagnostics take advantage of there being two microphones and two receivers. If the aids have wireless capability, control of the testing between aids may be coordinated using the wireless system. Otherwise, complicated interplay of acoustic output by the aids is used to control the testing, since the acoustic transducers are used to control and test each other. Independent means of assessing the transducers, as mentioned above, assists in problem differentiation.

According to various embodiments, action after testing includes several possibilities. In various embodiments, test results are stored in the aid for read-out by a fitter or dispenser and for use in future calibrations. If there is no way to communicate with the user (e.g., because a single-aid user has an aid with a nonfunctional receiver) the user can take the aid to the fitter or dispenser, at which time the test results might be read out. In various embodiments having a working receiver, voice messages may be given to the user through that receiver. In various embodiments, other indicia (e.g., a light on the housing that can be controlled by commands from the aid or aids) are used to communicate test results or other information to the user. If a dual-microphone array (or arrays) is used by the aids, test results may be used to change parameters of the array processing. If the aid seems still to be working but not responding within some tolerance of the manufacturer's calibration, then parameters of the signal processing are modified to correct for the changes.

In various embodiments the aid may be programmed to go into a “low-current” mode when diagnostics are finished. In various embodiments, the aid can be wakened from the mode when the aid no longer detects that it is in the housing.

In various embodiments the present subject matter provides a diagnostic apparatus for a hearing assistance device comprising a microphone and a receiver, the apparatus comprising: a housing configured to hold the hearing assistance device in a repeatable configuration to provide a controlled acoustic environment between the microphone and receiver, the housing including a lid to cover an opening in the housing to seal the housing from external sounds; and means for the housing to initiate a testing procedure conducted by the hearing assistance device. In variations the means is incorporated into the lid. In variations, the lid includes a magnetic signal source. In variations the lid includes a lever or protrusion adapted to initiate a testing mode in the hearing assistance device when closed on the housing. In variations the housing includes a magnetic or electromagnetic source adapted to provide a signal recognizable by the hearing assistance device to initiate the testing procedure. In variations the housing includes a direct audio input connector adapted to connect to the hearing assistance device, and wherein the direct audio input connector is adapted to provide a signal to the hearing assistance device to initiate the testing procedure. In variations the housing includes a charging device adapted to charge the hearing assistance device. In variations the present subject matter provides a method of testing a hearing aid having a microphone and a receiver, comprising: placing the hearing aid in an acoustically closed housing, the closed housing adapted to provide a repeatable acoustic environment to the hearing aid; and initiating a testing procedure performed by the hearing aid in the housing to determine if the microphone or the receiver is operational. Variations include method to initiate testing, including, but not limited to closing a lid on the housing, pressing a control on the housing, using a magnetic or electromagnetic source, and/or using a connector, including, but not limited to a direct audio connector to initiate testing. In variations the electrical connector can be used to communicate information with the hearing aid.

The present subject matter includes hearing assistance devices, including but not limited to, cochlear implant type hearing devices, hearing aids, such as behind-the-ear (BTE), in-the-ear (ITE), in-the-canal (ITC), or completely-in-the-canal (CIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user. It is understood that other hearing assistance devices not expressly stated herein may fall within the scope of the present subject matter. While the present disclosure refers to hearing aids, it is understood that any of the above-mentioned hearing assistance devices can be used without departing from the scope of the present subject matter.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A diagnostic apparatus for a hearing assistance device comprising a microphone and a receiver, the apparatus comprising:
a housing configured to hold the hearing assistance device in a repeatable configuration to provide a controlled acoustic environment between the microphone and receiver, the housing including a lid to cover an opening in the housing to seal the housing from external sounds; and
means for the housing to initiate a testing procedure conducted by the hearing assistance device.

2. The apparatus of claim 1, wherein the means is incorporated into the lid.

3. The apparatus of claim 2, wherein the lid includes a magnetic signal source.

4. The apparatus of claim 2, wherein the lid includes a lever or protrusion adapted to initiate a testing mode in the hearing assistance device when closed on the housing.

5. The apparatus of claim 1 wherein the housing includes a magnetic or electromagnetic source adapted to provide a signal recognizable by the hearing assistance device to initiate the testing procedure.

6. The apparatus of claim 1, further comprising a direct audio input connector adapted to connect to the hearing assistance device, and wherein the direct audio input connector is adapted to provide a signal to the hearing assistance device to initiate the testing procedure.

7. The apparatus of claim 1, further comprising a charging device adapted to charge the hearing assistance device.

8. The apparatus of claim 1, wherein the housing is adapted to hold a hearing aid.

9. The apparatus of claim 8, wherein the hearing aid includes a behind-the-ear (BTE) hearing aid.

10. The apparatus of claim 8, wherein the hearing aid includes an in-the-ear (ITE) hearing aid.

11. The apparatus of claim 8, wherein the hearing aid includes an in-the-canal (ITC) hearing aid.

12. The apparatus of claim 8, wherein the hearing aid includes a completely-in-the-canal (CIC) hearing aid.

13. A method of testing a hearing aid having a microphone and a receiver, comprising:
placing the hearing aid in an acoustically closed housing, the closed housing adapted to provide a repeatable acoustic environment to the hearing aid; and
initiating a testing procedure performed by the hearing aid in the housing to determine if the microphone or the receiver is operational.

14. The method of claim 13, wherein initiating a testing procedure includes closing a lid on the housing containing the hearing aid to initiate testing.

15. The method of claim 13, wherein initiating a testing procedure includes pressing a control on the housing containing the hearing aid to initiate testing.

16. The method of claim 13, wherein initiating a testing procedure includes using a magnetic source to initiate testing.

17. The method of claim 13, wherein initiating a testing procedure includes using an electromagnetic source to initiate testing.

18. The method of claim 13, further comprising connecting the hearing aid to an electrical connector.

19. The method of claim 18, further comprising using the electrical connector to initiate testing.

20. The method of claim 18, further comprising using the electrical connector to communicate information with the hearing aid.
